(19) United States
(12) Patent Application Publication
(10) Pub. No.: US 2023/0359925 A1
(43) Pub. Date: Nov. 9, 2023

(54) Predictive Severity Matrix

(71) Applicant: Capital One Services, LLC, McLean, VA (US)

(72) Inventors: Matthew Louis Nowak, Midlothian, VA (US); Christopher McDaniel, Glen Allen, VA (US); Michael Anthony Young, JR., Henrico, VA (US)

(21) Appl. No.: 17/661,960

(22) Filed: May 4, 2022

(51) Int. Cl. G06N 20/00

(52) U.S. Cl. CPC G06N 20/00

(57) ABSTRACT

Aspects described herein may use machine learning models to establishing severity designations for associating with a potential occurrence of an incident of an entity. Asset ownership data, development operations tools metric data, and severity matrix data are compiled and a relationship between the compiled data and new metric data is determined. Based upon the determined relationship, a new entry to add to the severity matrix data is predicted and a notification of the same is thereafter outputted.

### FIELD OF USE

Aspects of the disclosure relate generally to establishing severity designations for associating with a potential occurrence of an incident of an entity. More specifically, aspects of the disclosure provide techniques for using a machine learning model to predict relationships between data of new development operations tools metric data and data of existing severity matrix data within a data store of an entity.

### BACKGROUND

An incident severity matrix is a tool used by an entity to determine the severity of an incident. Such a tool is used during risk assessment to define the level of risk of occurrence of an incident by considering the category of probability, or likelihood, against the category of consequence severity. This is a tool used to increase the visibility of risks and assist management decision making Risk of the occurrence of an incident is the lack of certainty about the outcome of making a particular choice. The level of downside risk can be calculated as the product of the probability that harm occurs (that an incident happens) multiplied by the severity of that harm (the average amount of harm or, more conservatively, the maximum credible amount of harm). In practice, an incident severity matrix is a useful approach where either the probability or the harm severity cannot be estimated with accuracy and precision.

Severity on an incident severity matrix represents the severity of the most likely consequence of a particular incident occurrence. Accordingly, if an incident occurs and is not mitigated, what is the severity of the most likely problem that will occur thereafter. Some entities may use different criteria to define severity within its incident severity matrix. Different criteria provides a plurality of justifications for each risk assessment's severity. Each level of severity may utilize the same criteria but have an increase in damages/effect for each rising level of severity. When defining likelihood, criteria may be defined by either a quantitative approach: a number of expected incident occurrences or number of incident occurrences/resolution time period; or a qualitative approach, the relative chances of an incident occurring.

Thus, an incident severity matrix is based on the likelihood that the incident will occur, and the potential impact that the incident will have on the entity. It is a tool that helps an entity visualize the probability verses the severity of a potential incident. Depending on likelihood and severity, incidents may be categorized as high, moderate, or low. As part of the severity management process, entities may use incident severity matrices to help them prioritize different incidents and develop an appropriate mitigation strategy. Incidents come in many forms including strategic, operational, financial, and external. An incident severity matrix works by presenting various incidents by severity designations. An incident severity matrix also may include two axes: one that measures likelihood of an incident, and another that measures impact.

Although standard incident severity matrices may exist in certain contexts, individual projects and/or entities may need to create their own or tailor an existing incident severity matrix. The entity may calculate what levels of risk the entity can take with different events. This may be done by weighing the risk of an incident occurring against the cost to implement safety and the benefit gained from it. For entities, as they develop more applications and entity tools, they will update the incident severity matrix for each one.

Operational efficiency often is sought by entities. Many entities want their business to operate with as few incidents that require some form of mitigation to address. For example, cybersecurity is a sector of an entity's business that has increased substantially in recent years. Attacks from hackers and other nefarious individuals are a constant siege for an entity on a daily basis. An entity must manage these and other types of incidents constantly. Yet, when new applications for an entity are to be introduced and added to business functions of the entity, conventional systems for incident severity matrix creation and updating is slow and hampered by wasted time and resources.

FIG. 1 depicts an example of conventional manner in which a newly developed application at an entity is addressed. At step 101, a new application to implement may be developed by an entity. For example, an entity may develop a new service to be implemented as part of an application implemented for their website facing customers. For example, the new application may be associated with a service for using reward points of the entity to donate to a local charity. In response to the development of the application, some likely form of action occurs. In step 103, a severity matrix manager receives notification of the new application. The severity matrix manager may be someone within the entity that is assigned to address new applications when they are developed.

In step 105, the severity matrix manager manually determines severity designations for incidents that may occur upon implementation of the new application. For example, in the case of the new application being associated with a service for using reward points of the entity to donate to a local charity, the severity matrix manager may arbitrarily set severity designations to fit within a severity matrix tool of the entity based upon default criteria. In such a case, the severity matrix manager may determine the number of people that have to be effected by occurrence of an incident and/or the amount of time that an incident affecting a customer may have to meet different thresholds for the different severity designations. However, manual implementation by human interaction often leads to very long lead times for entry, inconsistent severity designations for potentially similar incidents and/or similar applications, and resistance to change when necessary.

In step 107, an incident occurs that is associated with the new application. For example, in the case of the new application being associated with a service for using reward points of the entity to donate to a local charity, a server that implements the new application may have a technical issue occur that causes the server to go offline. One or more customers may then not be able to access the service associated with the new application. As part of this step, an individual associated with the entity may review the incident severity matrix to determine the severity designation associated with the current number of customers affected and/or the amount of time of impact to customers.

Proceeding to step 109, because of one or more inaccurate severity designations within the incident severity matrix, the response time to mitigate the incident may be delayed. For example, due to an inaccurate designation, an individual reviewing the incident severity matrix may see that the severity designation for a particular incident is only low urgency and thus falls behind other incidents in priority when it comes to mitigating the occurrence of the incident. Because of this inaccurate entry in the incident severity matrix, any mitigation to handle reoccurrence of such an incident is further delayed.

In step 111, when the priority of the occurrence of the incident meets the severity designation of the incident severity matrix that warrants mitigation, one or more remediation actions may be performed to mitigate the incident. One or more individuals responsible for the entity resources affected by the new application perform the remediation actions. These remediation actions may be assigned to help make sure that the issues that caused the incident to occur do not occur again or are at least less likely to occur again. Thereafter in step 113, the severity matrix manager may manually determine adjustments needed to severity designations for incidents that may occur upon implementation of the new application. However, such manual adjustments only are made some time later when the severity matrix manager has the time and resources to perform the necessary manual act.

Aspects described herein may address these and other problems, and generally enable predicting relationships between data of new development operations tools metric data and data of existing severity matrix data within a data store of an entity. Such a prediction thereby reduces the likelihood that an occurrence of an incident affects an entity or unallowable number of customers of the entity or for an unallowable amount of time and reduces the time and resources spent in mitigating the occurrence of such an incident as quickly or efficiently as possible as the system operates proactively as opposed to reactively.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for the prediction and assignment of a new entry to add to a severity matrix data store of an entity. The new entry comprises data representative of a severity of a consequence of a particular incident occurrence affecting new metric data representative of a new development operations tools metric data of the entity. This may have the effect of significantly improving the ability of entities to ensure appropriate mitigation of occurrence of an incident affecting the entity or its customers, ensure individuals likely to be suited for mitigating incidents based upon a plurality of incidents are spending their time and resources mitigating incidents in an order based upon priority scheme of the entity for mitigating incidents, and improve incident management experiences for future incidents. According to some aspects, these and other benefits may be achieved by compiling ownership data, metric data, and severity matrix data and analyzing the compiled data, using one or more machine learning models, to predict a new entry to add to the severity matrix data. The ownership data may be representative of assets of an entity and data representative of relationships between the assets of the entity; the metric data may be representative of development operations tools metric data of the assets; and severity matrix data may comprise a plurality of entries. Each entry of the plurality of entries of severity matrix data may comprise data representative of a severity of a consequence of a particular incident occurrence affecting the metric data. The one or more machine learning models may be trained to recognize one or more relationships between the compiled data and new metric data representative of a new development operations tools metric data of the assets. The new entry may comprise data representative of a severity of a consequence of a particular incident occurrence affecting the new metric data. Such a prediction then may be used to accurately manage an incident severity matrix of an entity and efficiently and correctly prioritize mitigation of various incidents as they occur.

Aspects discussed herein may provide a computer-implemented method for the prediction and assignment of a new entry to add to a severity matrix data store. For example, in at least one implementation, a computing device may compile ownership data, metric data, and severity matrix data as input data to a machine learning model data store. The ownership data may be data representative of assets of an entity and data representative of relationships between the assets. The metric data may be data representative of development operations tools metric data of the assets of the entity. The severity matrix data may comprise a plurality of entries, where each entry comprises data representative of a severity of a consequence of a particular incident occurrence affecting the metric data.

The same computing device or different computing device may recognize one or more relationships between the compiled data and new metric data representative of a new development operations tools metric data of the assets, to predict a new entry to add to the severity matrix data. Such a new entry comprises data representative of a severity of a consequence of a particular incident occurrence affecting the new metric data. A computing device may output a notification of the predicted new entry.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of conventional manner in which a severity designation for an occurrence of a new incident at an entity is addressed;

FIG. 2 depicts an example of a computing environment that may be used in implementing one or more aspects of the disclosure in accordance with one or more illustrative aspects discussed herein;

FIG. 3 illustrates a system for predicting a severity designation as a new entry to a severity matrix data store of an entity in accordance with one or more aspects described herein;

FIGS. 4A-4B depict a flowchart for a method for predicting a severity designation as a new entry to a severity matrix data store of an entity in accordance with one or more aspects described herein;

FIGS. 5A-5B depict a flowchart for a method for modifying a severity designation of an existing entry in a severity matrix data store of an entity in accordance with one or more aspects described herein; and

FIG. 6 is an example of a severity matrix data store database including a plurality of applications with severity designations for incidents that may occur in accordance with one or more aspects described herein.

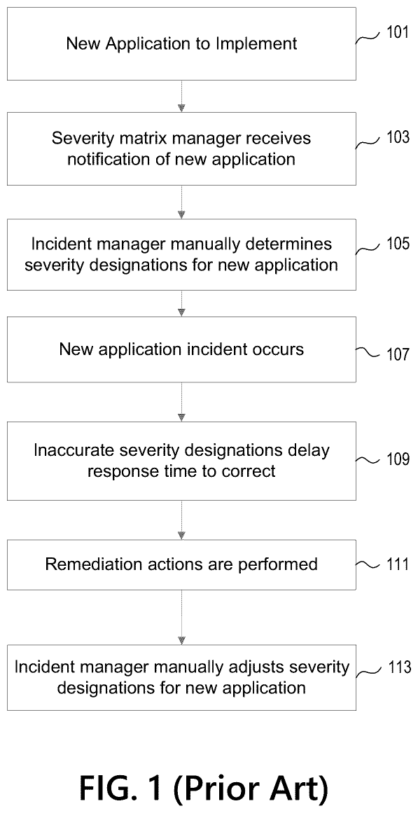

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for prediction and assignment of a new entry to add to a severity matrix data store. The new entry comprises data representative of a severity of a consequence of a particular incident occurrence affecting new metric data representative of a new development operations tools metric data of the entity. Illustrative examples include applications for ordering groceries, checking financial data, uploading photos as part of a social media application, and/or other uses. Upon implementation, the present disclosure describes receiving ownership data. The ownership data may be data representative of assets of an entity and data representative of relationships between the assets. The present disclosure further describes receiving metric data, which may be data representative of development operations tools metric data of the assets, and receiving severity matrix data, comprising a plurality of entries, where each entry comprises data representative of a severity of a consequence of a particular incident occurrence affecting the metric data.

A first computing device may compile the ownership data, the metric data, and the severity matrix data as input data to a machine learning model data store. As part of the compiling of such data, natural language processing may be utilized in order to account for textual and/or other data entries that do not consistently identify the same or similar data in the same way. The natural language processing may be utilized to identify text in data of various types and in various formats.

The same or a second computing device may receive new metric data. The new metric data may be representative of a new development operations tools metric data of the assets. Training data to a first machine learning model may be received. A first machine learning model may be trained to recognize one or more relationships between the input data in the machine learning model data store. The same, or a second, computing device may receive new metric data. The new metric data may be representative of a new development operations tools metric data of the assets. The new metric data may be used as refinement data to further train the first machine learning model. The refinement data may update the input data in the machine learning model data store based upon the new metric data. One or more specific characteristics of entries within the severity matrix data and the new metric data may be identified by one of the same or different computing devices. The one or more specific characteristics may include one or more of cloud infrastructure, physical infrastructure, a recovery time objective, or a customer base.

The present disclosure further describes a second machine learning model. Any of the same or a different computing device may predict, via the second machine learning model trained to recognize one or more relationships between the input data in the machine learning model data store and the new metric data, a new entry to add to the severity matrix data. The new entry may comprise data representative of a severity of a consequence of a particular incident occurrence affecting the new metric data.

The present disclosure further describes outputting a notification of the predicted new entry based upon the predicted new entry. After the output of the notification, a user input representative of a confirmation of adding the new entry to the severity matrix data or receiving a user input representative of a modification to the new entry to the severity matrix data may then be received. Thereafter, the new entry may be added to the severity matrix data and the second machine learning model may be modified based on the received user input.

Aspects described herein improve the functioning of computers by improving the ability of computing devices to identify and predict severity designations as part of a new entry to an existing severity matrix. Conventional systems are susceptible to failure or repetition of occurrence of a previous incident—for example, an inaccurate severity designation for the occurrence of an incident associated with a new application of an entity may lead to wasted time and resources to properly address the occurrence of an incident. As such, these conventional techniques leave entities exposed to the possibility of a constant reoccurrence of the incident on the operation of the entity as well as delayed response times to mitigating an incident to begin with. By providing prediction techniques—for example, based on predicting the likely severity designations to assign to occurrence of an incident for a new application—a proper remediation action scheme can be more accurately implemented in a more time efficient manner Over time, the processes described herein can save processing time, network bandwidth, and other computing resources. Moreover, such improvement cannot be performed by a human being with the level of accuracy obtainable by computer-implemented techniques to ensure accurate prediction of the severity designations.

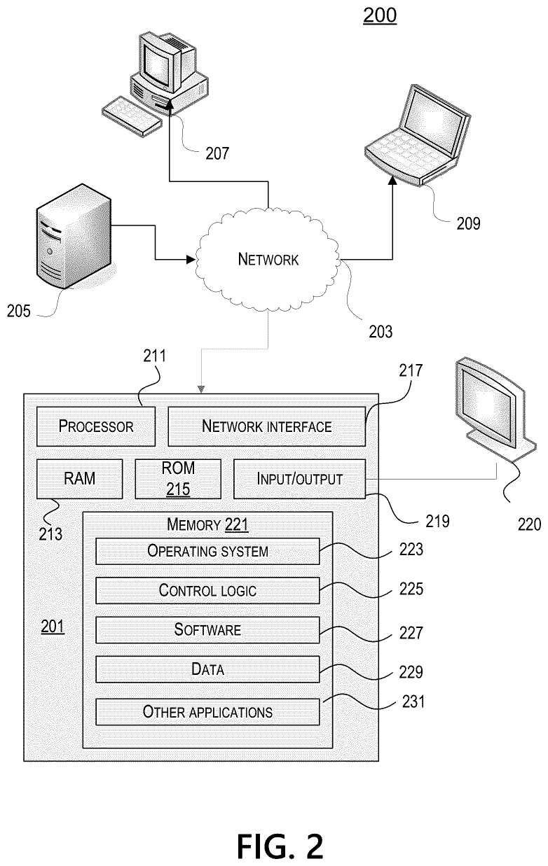

Before discussing these concepts in greater detail, however, several examples of a computing device and environment that may be used in implementing and/or otherwise providing various aspects of the disclosure will first be discussed with respect to FIG. 2.

FIG. 2 illustrates one example of a computing environment 200 and computing device 201 that may be used to implement one or more illustrative aspects discussed herein. For example, computing device 201 may, in some embodiments, implement one or more aspects of the disclosure by reading and/or executing instructions and performing one or more actions based on the instructions. In some embodiments, computing device 201 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

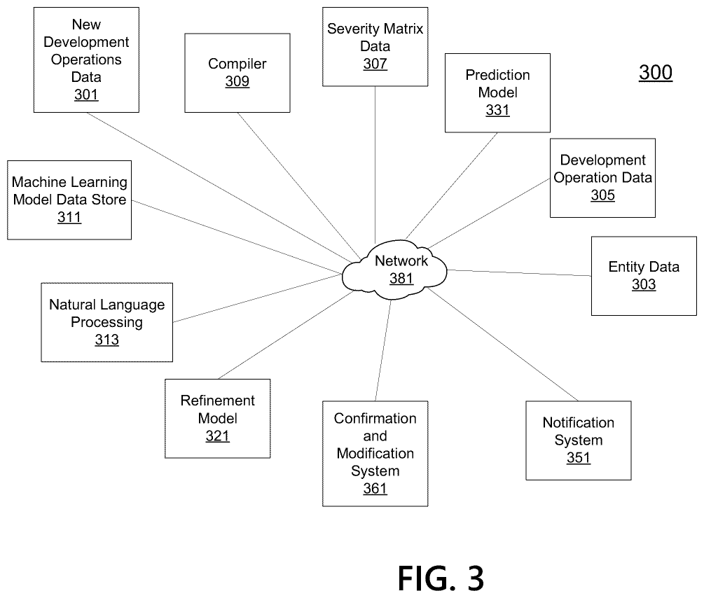

Computing device 201 may, in some embodiments, operate in a standalone environment. In others, computing device 201 may operate in a networked environment, including network 203 and network 381 in FIG. 3. As shown in FIG. 2, various network nodes 201, 205, 207, and 209 may be interconnected via a network 203, such as the Internet. Other networks may also or alternatively be used, including private intranets, corporate networks, local area networks (LANs), wireless networks, personal networks (PAN), and the like. Network 203 is for illustration purposes and may be replaced with fewer or additional computer networks. A LAN may have one or more of any known LAN topologies and may use one or more of a variety of different protocols, such as Ethernet. Devices 201, 205, 207, 209 and other devices (not shown) may be connected to one or more of the networks via twisted pair wires, coaxial cable, fiber optics, radio waves, or other communication media.

As seen in FIG. 2, computing device 201 may include a processor 211, RAM 213, ROM 215, network interface 217, input/output (I/O) interfaces 219 (e.g., keyboard, mouse, display, printer, etc.), and memory 221. Processor 211 may include one or more central processing units (CPUs), graphical processing units (GPUs), and/or other processing units such as a processor adapted to perform computations associated with machine learning. Processor 211 may control an overall operation of the computing device 201 and its associated components, including RAM 213, ROM 215, network interface 217, I/O interfaces 219, and/or memory 221. Processor 211 can include a single central processing unit (CPU) (and/or graphic processing unit (GPU)), which can include a single-core or multi-core processor along with multiple processors. Processor(s) 211 and associated components can allow the computing device 201 to execute a series of computer-readable instructions to perform some or all of the processes described herein. A data bus can interconnect processor(s) 211, RAM 213, ROM 215, memory 221, I/O interfaces 219, and/or network interface 217.

I/O interfaces 219 may include a variety of interface units and drives for reading, writing, displaying, and/or printing data or files. I/O interfaces 219 may be coupled with a display such as display 220. I/O interfaces 219 can include a microphone, keypad, touch screen, and/or stylus through which a user of the computing device 201 can provide input, and can also include one or more of a speaker for providing audio output and a video display device for providing textual, audiovisual, and/or graphical output.

Network interface 217 can include one or more transceivers, digital signal processors, and/or additional circuitry and software for communicating via any network, wired or wireless, using any protocol as described herein. It will be appreciated that the network connections shown are illustrative and any means of establishing a communications link between the computers or other devices can be used. The existence of any of various network protocols such as TCP/IP, Ethernet, FTP, Hypertext Transfer Protocol (HTTP) and the like, and various wireless communication technologies such as Global system for Mobile Communication (GSM), Code-division multiple access (CDMA), WiFi, and Long-Term Evolution (LTE), is presumed, and the various computing devices described herein can be configured to communicate using any of these network protocols or technologies.

Memory 221 may store software for configuring computing device 201 into a special purpose computing device in order to perform one or more of the various functions discussed herein. Memory 221 may store operating system software 223 for controlling overall operation of computing device 201, control logic 225 for instructing computing device 201 to perform aspects discussed herein, software 227, data 229, and other applications 231. Control logic 225 may be incorporated in and may be a part of software 227. In other embodiments, computing device 201 may include two or more of any and/or all of these components (e.g., two or more processors, two or more memories, etc.) and/or other components and/or subsystems not illustrated here.

Devices 205, 207, 209 may have similar or different architecture as described with respect to computing device 201. Those of skill in the art will appreciate that the functionality of computing device 201 (or device 205, 207, 209) as described herein may be spread across multiple data processing devices, for example, to distribute processing load across multiple computers, to segregate transactions based on geographic location, user access level, quality of service (QoS), etc. For example, devices 201, 205, 207, 209, and others may operate in concert to provide parallel computing features in support of the operation of control logic 225 and/or software 227.

Although not shown in FIG. 2, various elements within memory 221 or other components in computing device 201, can include one or more caches including, but not limited to, CPU caches used by the processor 211, page caches used by an operating system, disk caches of a hard drive, and/or database caches used to cache content from a data store. For embodiments including a CPU cache, the CPU cache can be used by one or more processors 211 to reduce memory latency and access time. Processor 211 can retrieve data from or write data to the CPU cache rather than reading/writing to memory 221, which can improve the speed of these operations. In some examples, a database cache can be created in which certain data from a data store is cached in a separate smaller database in a memory separate from the data store, such as in RAM 215 or on a separate computing device. For instance, in a multi-tiered application, a database cache on an application server can reduce data retrieval and data manipulation time by not needing to communicate over a network with a back-end database server. These types of caches and others can be included in various embodiments, and can provide potential advantages in certain implementations of devices, systems, and methods described herein, such as faster response times and less dependence on network conditions when transmitting and receiving data.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) Python, Perl, or an equivalent thereof. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Although various components of computing device 201 are described separately, functionality of the various components can be combined and/or performed by a single component and/or multiple computing devices in communication without departing from the invention. Having discussed several examples of computing devices that may be used to implement some aspects as discussed further below, discussion will now turn to various examples for predicting a new entry for a severity matrix.

FIG. 3 illustrates a system 300 for predicting and assigning a new entry to add to a severity matrix data store of an entity. The operating environment 300 may include computing devices 309, 313, 321, and 331, memories or databases 301, 303, 305, 307, and 311, a confirmation and modification system 361, and a notification system 351 in communication via a network 381. Network 381 may be network 203 in FIG. 2. It will be appreciated that the network 381 connections shown are illustrative and any means of establishing a communications link between the computing devices, remediation performance system, and memories or databases may be used. The existence of any of various network protocols such as Transmission Control Protocol/Internet Protocol (TCP/IP), Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing devices and/or network described with respect to FIG. 2.

As shown in FIG. 3, the system 300 may include one or more memories or databases that maintains new development operations data 301. A computing device utilizing natural language processing 313 may be configured to access the one or more memories or databases that maintains new development operations data 301. The new development operations data 301 may include data representative of a new development operations tools metric data of one or more assets and an entity. The new development operations data 301 may be data points that directly reveal the performance of a software development pipeline and assist in quickly identifying and removing any blockages in the process. These metrics may be used to track both technical capabilities and team processes. Development operations tools metric data may include metrics that are measurable to a value for an entity. Value designations may be based upon a scale in order to provide tangible measured data for the applicable metric. Development operations tools metric data may include metrics that measure that which is important for an entity. Development operations tools metric data may include metrics in which individuals, such as team members, cannot change or otherwise affect measurement results. Development operations tools metric data may include analysis of the metrics over time that provides insights on possible improvements of some system, workflow, policy, etc. of an entity. Development operations tools metric data may include metrics that directly identifies a root cause of an incident as opposed to an indication that something is wrong. Development operations tools metric data further may include metric data such as development lead time, idle time, and/or cycle time. Development operations tools metric data further may include mean time to failure data, e.g., a period of time from product/feature launch to the first failure, which is characterized by uninterrupted availability of service and correct system behavior until a failure occurs. Development operations tools metric data further may include mean time to detection data, e.g., a period of time from the incident occurring to an individual being informed of the incident and diagnosing its root cause. This metric identifies the efficiency of incident tracking and monitoring systems. Development operations tools metric data further may include mean time to recovery, e.g., a period of time between finding a root cause and correcting the incident. Such metric includes code complexity, development operations workflow maturity, operational flexibility, and a variety of other parameters. Development operations tools metric data further may include mean time between failures, e.g., the period of time between a next failure of the same type occurring. Such a metric highlights an entity's system stability and process reliability over time. Examples of development operations tools metric data include periodic scan data for a development operations tool, such as Eratocode, and product change information including metric values as of time of product changes.

Illustrative examples of development operations tool metric data includes:
deployment frequency (whether one or both of production and non-production deployments, tracking how often an entity does deployments),
change volume (tracking changes in overall application performance after deployment, e.g., web service calls, SQL queries, etc.),
deployment time (tracking how long it takes to do an actual deployment),
lead time (the amount of time that occurs between starting on a work item until it is deployed),
customer tickets (customer support tickets and feedback),
automated test pass percentage (tracking how well your automated tests work),
defect escape rate (track how often software defects make it to production),
availability (tracking scheduled maintenance and all unplanned outages),
service level agreements (track compliance with service level agreements),
failed deployments (tracking the number of failed deployments)
error rates (tracking new exceptions in code after a deployment (bugs) and tracking issues with database connections, query timeouts, and other production issues),
application usage and traffic (after a deployment, tracking to see if the amount of transactions or users accessing an entity system appears normal or expected),
mean time to detection (MTTD, measures the average time it takes an entity to be first alerted to an application failure),
mean time to failure (MTTF, average time between non-repairable failures of an application)
mean time to repair (average time it takes an entity to repair its system),
mean time to recovery (MTTR, average amount of time it takes an application to recover from a failure),
mean time between failures (the average time between repairable failures of an application),
mean time to resolve (the time spent to ensure that the failure will not happen again), and
mean time to respond (measures the average time it takes to recover from a failure as measured from the time when an entity was first alerted to the problem).

New development operations data 301 further may be used by refinement model 321 trained to recognize one or more relationships between the input data in a machine learning model data store 311. As described below, the refinement model 321 updates the input data in the machine learning model data store 311 based upon the new development operations metric data 301.

The system 300 may include one or more memories or databases that maintains entity data 303. A computing device utilizing natural language processing 313 may be configured to access the one or more memories or databases that maintains entity data 303. The entity data 303 may include data representative of assets of an entity. Assets of an entity may include computing devices, databases, servers, facilities, software, firmware, and/or other equipment of the entity. The entity data 303 also may include data representative of associations between the assets of the entity. In some embodiments, entity data 303 may include data representative of support team ownership data and/or line of business ownership data, e.g., data for one or more members of a support team and/or line of business of the entity that is responsible for operation, implementation, and/or development of one or more pieces of equipment of the entity, including software and/or firmware operating on a physical piece of equipment and/or software and/or firmware implementing specific code of the entity, such as an application.

The system 300 may include one or more memories or databases that maintains development operations data 305. A computing device utilizing natural language processing 311 may be configured to access the one or more memories or databases that maintains development operations data 305. The development operations data 305 may include data representative of development operations tools metric data, as described above, that are already in implementation by the entity.

The system 300 may include one or more memories or databases that maintains severity matrix data 307. A computing device utilizing natural language processing 313 may be configured to access the one or more memories or databases that maintains severity matrix data 307. The severity matrix data 307 may include a plurality of entries, where each entry includes data representative of a severity of a consequence of a particular incident occurrence affecting the metric data. Severity in an entry within the severity matrix 307 may represent the severity of the most likely consequence of a particular incident occurrence. Thus, severity matrix data may be based on the likelihood that incidents with respect to an application will occur, and the potential impact that the incidents will have on the entity. It is a tool that helps an entity visualize the probability verses the severity of a potential incident.

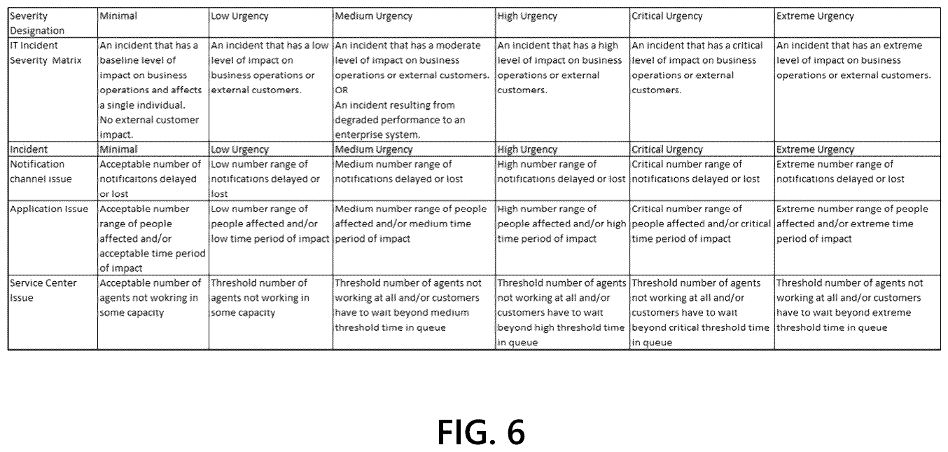

FIG. 6 is an example of a severity matrix data store database including a plurality of applications with severity designations for incidents that may occur in accordance with one or more aspects described herein. In the example shown, there are six different severity designations for a type of incident that may occur with respect to implementation/integration of an application of an entity. Although the examples shown include minimal, low urgency, medium urgency, high urgency, critical urgency, and extreme urgency, fewer than six designations for a severity level may be included. In addition, different terminology may be utilized to the same affect, e.g., a scale of low, medium, and high severity designations. As shown in the illustrative example of FIG. 6, entries within the severity matrix data may include data regarding threshold number ranges/thresholds and/or threshold time periods that an entity utilizes to designate a particular severity for an incident occurrence. For example, the number of customers affected if a first application is not operating properly might have a smaller threshold number to reach a “high urgency” designation in comparison to a second application that is not operating properly. In such a case, a particular incident affecting the first application may be a more problematic incident to address since the number of customers affected to be classified as such within the severity matrix data 307 is smaller in comparison to a similar incident occurring with respect to the second application. Any of a number of different applications and types of incidents per application may be included within severity matrix data 307. In addition, as described herein, updates to modify existing entries or to add new entries may be implemented and maintained within severity matrix data 307.

System 300 may include one or more computing devices as a compiler 309 for compiling the entity data 303, the development operations tools metric data 305, and/or the severity matrix data 307. Compiler 309 may bring together the entity data 303, the development operations tools metric data 305, and/or the severity matrix data 307 for use as input data to a machine learning model data store 311. Compiler 309 may utilize natural language processing 313 in order to modify data for storage in the machine learning model data store 311. Compiler 309 may be configured to load various data from the entity data 303, development operations tools metric data 305, and/or severity matrix data 307, in order to create one or more derived fields for use in the machine learning model data store 311. Derived fields may include data entries that do not exist in the machine learning model data store 311 itself. Rather, they are calculated from one or more existing numeric fields via basic arithmetic expressions and non-aggregate numeric functions.

System 300 may include one or more computing devices utilizing natural language processing 313. The one or more computing devices utilizing natural language processing 313 may receive data and/or access data from one or more of memories or databases 301, 303, 305, 307, and 311. Natural language processing 313 may be utilized in order to account for textual and/or other data entries that do not consistently identify the same or similar data in the same way. The natural language processing 313 may be utilized to identify text in data of various types and in various formats.

The system 300 may include one or more memories or databases storing a machine learning model data store 311 that maintains data as input to a refinement model 321 and/or a prediction model 331. Machine learning model data store 311 may be configured to maintain data elements used in refinement model 321 and prediction model 331 that may not be stored elsewhere, or for which runtime calculation is either too cumbersome or otherwise not feasible. Examples include point-in-time historical values of development operations attribute values, development operations attribute values as of time of production change, and historical production asset ownership information. Any derived fields related to rates of change of these attributes, historical trend information that might be predictive, as well as model specifications may be maintained here as well.

System 300 may include one or more computing devices implementing a refinement model 321. Refinement model 321 may be a machine learning model. The machine learning model may comprise a neural network, such as a convolutional neural network (CNN), a recurrent neural network, a recursive neural network, a long short-term memory (LSTM), a gated recurrent unit (GRU), an unsupervised pre-trained network, a space invariant artificial neural network, a generative adversarial network (GAN), or a consistent adversarial network (CAN), such as a cyclic generative adversarial network (C-GAN), a deep convolutional GAN (DC-GAN), GAN interpolation (GAN-INT), GAN-CLS, a cyclic-CAN (e.g., C-CAN), or any equivalent thereof. Additionally or alternatively, the machine learning model may comprise one or more decisions trees. Refinement model 321 may be trained to recognize one or more relationships between the input data in the machine learning model data store 311. The machine learning model may be trained using supervised learning, unsupervised learning, back propagation, transfer learning, stochastic gradient descent, learning rate decay, dropout, max pooling, batch normalization, long short-term memory, skip-gram, or any equivalent deep learning technique. Once trained, the refinement model may update the input data in the machine learning model data store 311. Specifically, refinement model 321 may be configured to discern an objective relationship between the data captures for production assets in the machine learning model data store 311. The output of refinement model 321 may include refined model data that is then maintained in the machine learning model data store 311. The refined model data thereafter may be used as input to prediction model 331.

System 300 may include one or more computing devices implementing a prediction model 331. Prediction model 331 may be a machine learning model. The machine learning model may be any of the machine learning models described above with respect to the refinement model 321. Prediction model 331 may be trained, using the techniques described above, to recognize one or more relationships between the input data in the machine learning model data store 311 and new development operations metric data 301. In addition, prediction model 331 utilizes the body of attributes maintained in the machine learning model data store 311. Prediction model 331 may identify one or more specific characteristics of entries within the severity matrix data 307 and the new development operations data 301. The one or more characteristics may include any one or more of cloud infrastructure, physical infrastructure, a recovery time objective, or a customer base.

Prediction model 331 may predict a new entry to add to the severity matrix data 307 based upon the input data from the machine learning model data store 311. Once implemented, prediction model 331 may output to machine learning model data store 311. In addition, prediction model 331 may output to a notification system 351 to output a notification of the predicted new entry. Illustrative notifications include an alert of some type, an email, an instant message, a phone call, and/or some other type of notification.

Prediction model 331 may be trained to output a score representative of a confidence of the basis for the severity, within the new entry, of a consequence of a particular incident occurrence affecting the new development operations data 301. Such a score may be generated based on the predicted relationship. A score may be a numerical value associated with a designated scale with a higher value corresponding to higher confidence determination. In some embodiments, each score may be compared to a threshold value. The threshold value may be a score requirement for providing a score to a user. When a score satisfies the threshold value, the predicted new entry may be outputted via a notification to a user. In some embodiments, a notification may not be outputted unless the score satisfies a threshold. In some embodiments, additional scores representative of other confidence determinations may be outputted. Such additional scores may be generated based on the predicted relationships. In embodiments in which there are multiple scores, the prediction model 331 may output a notification based on one or more of the plurality of scores. In embodiments of multiple scores, different incidents, development operations data 301, and/or applications may have different thresholds to satisfy. In some embodiments, the predictive model 331 may compare a plurality of scores with each other and output a notification based on the comparison, such as one score being higher in value than a second score.

As described herein, system 300 includes a notification system 351 configured to output a notification of the predicted new entry. The notification system 351 may be configured to receive a plurality of new entry options based upon scores and may determine which of the plurality to output as part of the notification. Alternatively, notification system 351 may be configured to output all possible new entry options based upon a score meeting a threshold. Further, notification system 351 may be configured to output a notification of all possible new entries that were determined with the corresponding score for each included in the notification.

System 300 also includes confirmation and modification system 361. Confirmation and modification system 361 may include receiving user input that is representative of a confirmation of adding the new entry to the severity matrix data 307. System 300 may be configured to be completely autonomous where predicted new entries are automatically added to the severity matrix data 307. Alternatively, system 300 may be configured to require a confirmation by a user prior to adding the new entry to the severity matrix data 307. The user may confirm all, some, or no portion of the new entry that the system has predicted. In some occurrences, the user may want to modify the predicted new entry prior to updating the severity matrix data 307. Confirmation and modification system 361 may include receiving a user input representative of a modification to the predicted new entry to the severity matrix data 307. This user confirmation and/or user override may be feedback data to the machine learning model data store 311, refinement model 321, and/or prediction model 331. Such an update may include creating, in the database maintaining the severity matrix data 307, a new database entry comprising data representative of a severity of a consequence of a particular incident occurrence affecting the development operations data 301 that is based upon a change made by the user.

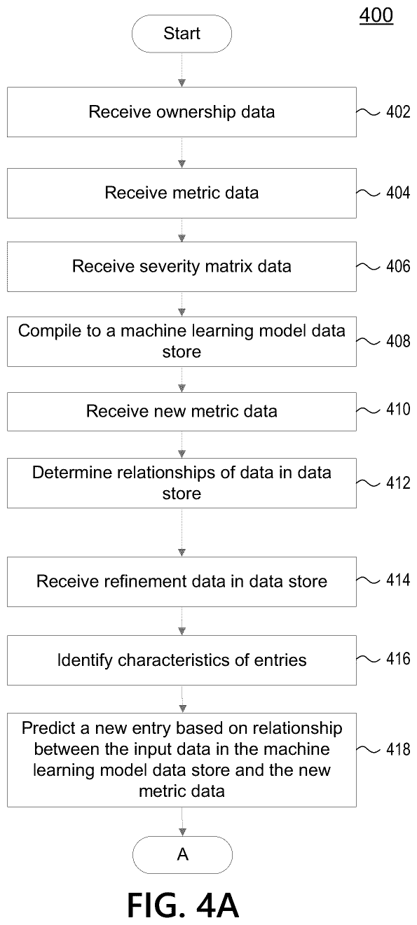

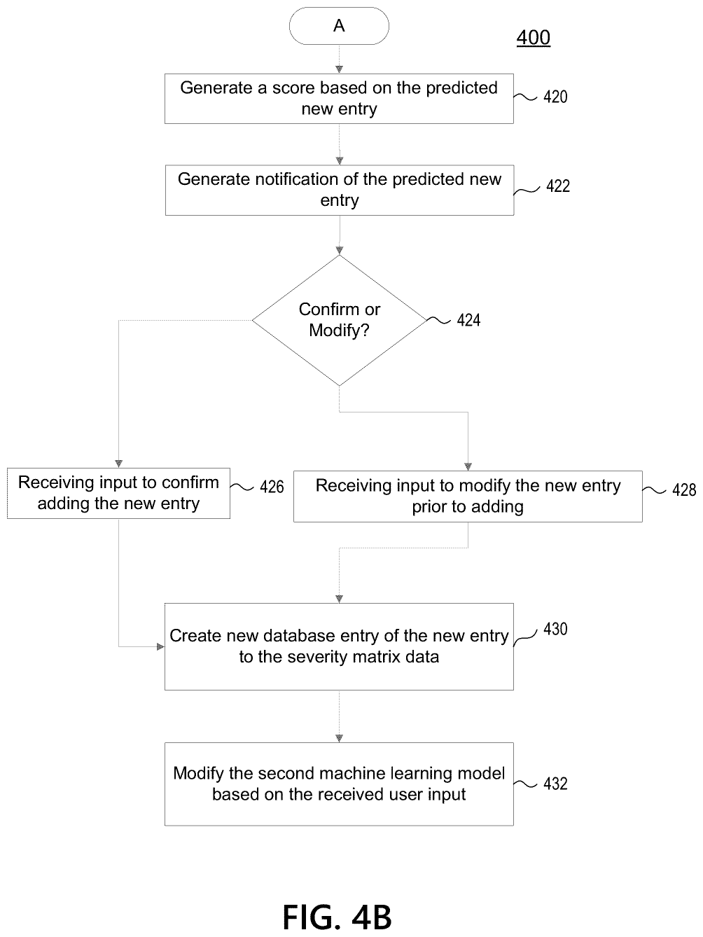

FIGS. 4A-4B depict a flowchart for a method for predicting a severity designation as a new entry to a severity matrix data store of an entity. Some or all of the steps of method 400 may be performed using a system that comprises one or more computing devices as described herein, including, for example, computing device 201, or computing devices in FIG. 2, and computing devices in FIG. 3.

At step 402, one or more computing devices may receive ownership data. Ownership data may be maintained in a memory of a computing device and/or as part of a database or other memory location accessible by a computing device, such as entity data 303 in FIG. 3. The ownership data may include data representative of assets of an entity. Some assets of the entity may have been involved in one or more incidents in which mitigation of an incident was needed while others may not have been. Illustrative examples of an incident include the destruction of entity equipment, a cybersecurity attack on equipment of an entity, a power outage effecting equipment of an entity, and data corruption associated with equipment of an entity. The ownership data also may include data representative of associations between the assets of the entity. For example, two assets (e.g., pieces of equipment) may both be maintained within a certain building of the entity. Thus, a fire at the certain building may affect both assets. Two or more assets also may be associated with each other as they provide data to and/or receive data from the other asset. For example, an application on a mobile device may access a user authentication server to ensure a user has access rights to certain data and the application may separately access a database that maintains content desired by the user. Accordingly, there may be an association established between the application and the authentication server and between the application and the database and/or between the application, the authentication server, and the database.

At step 404, one or more computing devices may receive development operations data. Development operations data may be maintained in a memory of a computing device and/or as part of a database or other memory location accessible by a computing device, such as development operations data 305 in FIG. 3. The development operations data may include data representative of development operations tools metric data.

At step 406, one or more computing devices may receive severity matrix data. Severity matrix data may be maintained in a memory of a computing device and/or as part of a database or other memory location accessible by a computing device, such as severity matrix data 307 in FIG. 3. The severity matrix data may include a severity matrix of an entity. FIG. 6 is an illustrative example of at least a portion of severity matrix data.

At step 408, one or more computing devices may compile the ownership data, the development operations tools metric data, and the severity matrix data for use as input data to one or more machine learning model data stores. Compiling of data may be implemented by compiler 309 as described for FIG. 3. As part of the process of compiling the various data, natural language processing may be utilized in order to account for textual and other data entries that do not consistently identify the same or similar data in the same way. The natural language processing may be utilized to identify text in data of various types and in various formats. The identified text may be grouped with similarly identified text into various fields for eventual use in a machine learning model data store. The compiled data may be maintained in a memory as needed for use in one or more machine learning models. The various fields of data may include time series data, incident cause data, device impact data, scoring data, notification data, and user confirmation data as described herein.

At step 410, one or more computing devices may receive new development operations tools metric data. New development operations tools metric data may be maintained in a memory of a computing device and/or as part of a database or other memory location accessible by a computing device, such as new development operations data 301 in FIG. 3. The new development operations tools metric data may include data representative of a new development operations tools metric data of one or more assets and an entity.

Moving to step 412, input data may be inputted to a refinement model to recognize one or more relationships between the input data in a machine learning model data store. As described herein, the refinement data may update the input data in the machine learning model data store. Such a refinement model may be refinement model 321 described in FIG. 3. The input data may be obtained from a machine learning model data store, such as machine learning model data store 311 as described in FIG. 3. The output of the refinement model may include refinement data. In step 414, refinement data may be received by a machine learning model data store. The refinement data may be used to update the input data in the machine learning model data store.

Moving to step 416, input data from machine learning model data store, which may include refinement data, may be inputted to a machine learning model trained to recognize one or more relationships between the input data in the machine learning model data store and new development operations data. The machine learning model may operate on one or more computing devices, such as the one or more computing devices in FIGS. 2 and 3. The machine learning model may be a prediction model, such as prediction model 331 described in FIG. 3. New development operations data may comprise data from new development operations data 301. In step 418, the machine learning model may predict a new entry to be added to the severity matrix of the entity based upon at least one relationship between the input data in the data store and the new development operations data. This severity matrix data may be severity matrix data 307 in FIG. 3.

Proceeding to step 420 in FIG. 4B, the machine learning model may output a score representative of a confidence of the basis for the severity, within the new entry, of a consequence of a particular incident occurrence affecting the new development operations data. Step 420 may be implemented for a number of incidents and number of new operations development data. A score may be a numerical value associated with a designated scale with a higher value corresponding to higher confidence determination. The one or more computing devices implementing step 420 may be one or more of the same computing devices described in FIGS. 2 and 3. In some embodiments, each score may be compared to a threshold value. A score may be a numerical value associated with a designated scale with a higher value corresponding to higher confidence determination. In some embodiments, each score may be compared to a threshold value. The threshold value may be a score requirement for providing a score to a user. Such additional scores may be generated based on the predicted relationships. In some embodiments, the machine learning model may compare a plurality of scores with each other and output a notification based on the comparison, such as one score being higher in value than a second score.

In step 422, the machine learning model may output a notification of the predicted new entry to a user. In some embodiments, a notification may not be outputted unless the score satisfies a threshold. In some embodiments, additional scores representative of other confidence determinations may be outputted. Such additional scores may be generated based on the predicted relationships. In embodiments in which there are multiple scores, the machine learning model may output a notification based on one or more of the plurality of scores. In embodiments of multiple scores, different incidents, development operations data, and/or applications, each may have different thresholds to satisfy. In some embodiments, the machine learning model may compare a plurality of scores with each other and output a notification based on the comparison, such as one score being higher in value than a second score. Illustrative notifications include an alert of some type, an email, an instant message, a phone call, and/or some other type of notification. Accordingly, an individual may receive an email message indicating a predicted new entry to add to the entity's severity matrix based upon the new development operations data. The notification may include a request to confirm the predicted entry or to modify the predicted entry.

Proceeding to step 424, a determination may be made as to whether the predicted new entry is confirmed or modified by a user. For step 424, the system may receive a user input representative of a confirmation of adding the predicted new entry to the severity matrix data and follow to step 426. Alternatively, the system may receive a user input representative of a modification to the predicted new entry to the severity matrix data and follow to step 428. If the system receives, in step 426, a user input representative of a confirmation of adding the predicted new entry to the severity matrix data, the system may determine that the predicted new entry from the machine learning model predicted in step 418, scored in step 420, and notified to a user in step 422 is to be added to the severity matrix data of the entity. In the alternative, if the system receives, in step 428, a user input representative of a modification to the predicted new entry to the severity matrix data, the system may determine that the predicted new entry from the machine learning model predicted in step 418, scored in step 420, and notified to a user in step 422 is to be added to the severity matrix data of the entity per one or more modifications by the user. For example, the user may change a portion of the predicted new entry to have a different number range for a number of customers affected by a specific incident for a specific severity designation. Accordingly, any modifications to the predicted new entry by the user may be received as part of step 428 as well. An individual may accept or reject any particular portion of the predicted new entry before proceeding to step 430. In alternative embodiments, no user confirmation may be needed. This may be a situation in which the system operates autonomously and merely creates new database entries automatically without user confirmation before proceeding to step 432. Steps 424-428 may be implemented by receiving such confirmation data at a confirmation and modification system 361 as described in FIG. 3.

In step 430, a new database entry in the severity matrix data and/or the machine learning model data store may be created. The new database entry may include the predicted new entry automatically or the user confirmed predicted new entry, whether modified by a user or not. Accordingly, the severity matrix data and/or machine learning model data store now has been updated to account for the new development operations data. Again, this process may occur separately or concurrently for many incidents and/or new development operations data. Finally, in step 432, the machine learning model, such as prediction model 331 described in FIG. 3, may be modified to account for the confirmation of the predicted new entry by the user in step 426 or the modification of the predicted ne entry by the user in step 428.

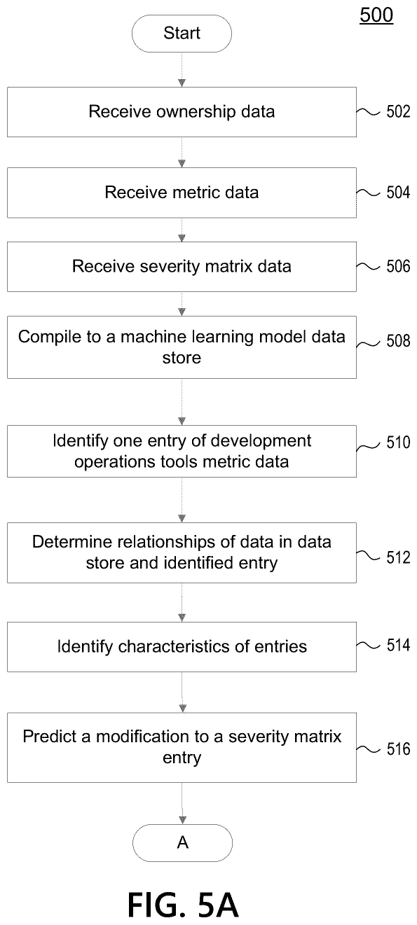

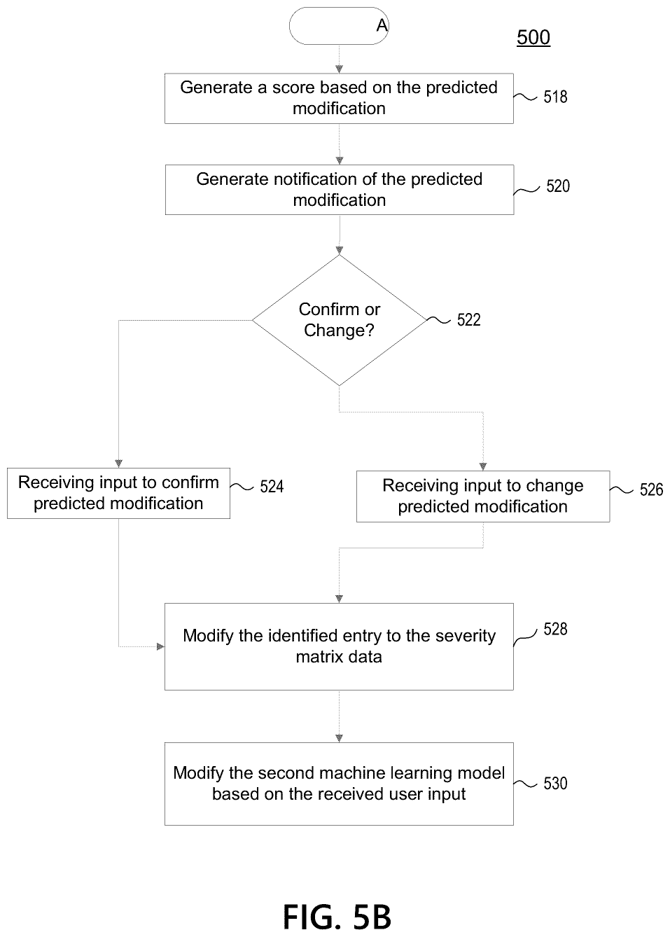

FIGS. 5A-5B depict a flowchart for a method for modifying a severity designation of an existing entry in a severity matrix data store of an entity. Some or all of the steps of method 500 may be performed using a system that comprises one or more computing devices as described herein, including, for example, computing device 201, or computing devices in FIG. 2, and computing devices in FIG. 3.

At step 502, one or more computing devices may receive ownership data. Ownership data may be maintained in a memory of a computing device and/or as part of a database or other memory location accessible by a computing device, such as entity data 303 in FIG. 3. The ownership data may include data representative of assets of an entity. Some assets of the entity may have been involved in one or more incidents in which mitigation of an incident was needed while others may not have been. The ownership data also may include data representative of associations between the assets of the entity. Two or more assets also may be associated with each other as they provide data to and/or receive data from the other asset. Accordingly, there may be an association established between the application and the authentication server and between the application and the database and/or between the application, the authentication server, and the database.

At step 504, one or more computing devices may receive development operations data. Development operations data may be maintained in a memory of a computing device and/or as part of a database or other memory location accessible by a computing device, such as development operations data 305 in FIG. 3. The development operations data may include data representative of development operations tools metric data.

At step 506, one or more computing devices may receive severity matrix data. Severity matrix data may be maintained in a memory of a computing device and/or as part of a database or other memory location accessible by a computing device, such as severity matrix data 307 in FIG. 3. The severity matrix data may include a severity matrix of an entity. FIG. 6 is an illustrative example of at least a portion of severity matrix data.

At step 508, one or more computing devices may compile the ownership data, the development operations tools metric data, and/or the severity matrix data for use as input data to one or more machine learning model data stores. Compiling of data may be implemented by compiler 309 as described for FIG. 3. As part of the process of compiling the various data, natural language processing may be utilized in order to account for textual and other data entries that do not consistently identify the same, or similar, data in the same way. The natural language processing may be utilized to identify text in data of various types and in various formats. The identified text may be grouped with similarly identified text into various fields for eventual use in a machine learning model data store. The compiled data may be maintained in a memory as needed for use in one or more machine learning models. The various fields of data may include time series data, incident cause data, device impact data, scoring data, notification data, and user confirmation data as described herein.

At step 510, one or more computing devices may identify one entry of the development operations tools metric data. The entry of the development operations tools metric data may be maintained in a memory of a computing device and/or as part of a database or other memory location accessible by a computing device, such as development operations data 305 in FIG. 3. The development operations tools metric data may include data representative of an existing entry within the development operations tools metric data of one or more assets and an entity.

Moving to step 512, input data may be inputted to a refinement model to recognize one or more relationships between the input data in a machine learning model data store. As described herein, the refinement data may update the input data in the machine learning model data store. Such a refinement model may be refinement model 321 described in FIG. 3. The input data may be obtained from a machine learning model data store, such as machine learning model data store 311 as described in FIG. 3. The output of the refinement model may include refinement data. Step 512 further may include the refinement data being received by a machine learning model data store. The refinement data may be used to update the input data in the machine learning model data store.

Moving to step 514, input data from machine learning model data store, which may include refinement data, may be inputted to a machine learning model trained to recognize one or more relationships between the input data in the machine learning model data store and the identified entry in the development operations data. The machine learning model may operate on one or more computing devices, such as the one or more computing devices in FIGS. 2 and 3. The machine learning model may be a prediction model, such as prediction model 331 described in FIG. 3. In step 516, the machine learning model may predict a modification to one or more entries within the severity matrix data based upon at least one relationship between the input data in the data store and the identified entry in the development operations data. This severity matrix data may be severity matrix data 307 in FIG. 3. Step 516 looks to check existing data against ongoing changes to the machine learning models and the machine learning model data store to determine if changes within one or more entries of the severity matrix data maintained for an entity needs to be implemented.

Proceeding to step 518 in FIG. 5B, the machine learning model may output a score representative of a confidence of the basis for the severity, within the new entry, of a consequence of a particular incident occurrence affecting the development operations data based upon the predicted modification. Step 518 may be implemented for a number of incidents and number of operations development data. A score may be a numerical value associated with a designated scale with a higher value corresponding to higher confidence determination. The one or more computing devices implementing step 518 may be one or more of the same computing devices described in FIGS. 2 and 3. In some embodiments, each score may be compared to a threshold value. A score may be a numerical value associated with a designated scale with a higher value corresponding to higher confidence determination. In some embodiments, each score may be compared to a threshold value. The threshold value may be a score requirement for providing a score to a user. Such additional scores may be generated based on the relationships. In some embodiments, the machine learning model may compare a plurality of scores with each other and output a notification based on the comparison, such as one score being higher in value than a second score.

In step 520, the machine learning model may output a notification of the predicted modification to a user. In some embodiments, a notification may not be outputted unless the score satisfies a threshold. In some embodiments, additional scores representative of other confidence determinations may be outputted. Such additional scores may be generated based on the relationships. In embodiments in which there are multiple scores, the machine learning model may output a notification based on one or more of the plurality of scores. In embodiments of multiple scores, different incidents, development operations data, and/or applications may have different thresholds to satisfy. In some embodiments, the machine learning model may compare a plurality of scores with each other and output a notification based on the comparison, such as one score being higher in value than a second score. The notification may include a request to confirm the predicted modification or to change the predicted modification.

Proceeding to step 522, a determination may be made as to whether the predicted modification is confirmed or changed by a user. For step 522, the system may receive a user input representative of a confirmation of the predicted modification to an identified entry in the severity matrix data and follow to step 524. Alternatively, the system may receive a user input representative of a change to predicted modification of an identified entry in the severity matrix data and follow to step 526. If the system receives, in step 524, a user input representative of a confirmation of the predicted modification to an identified entry in the severity matrix data, the system may determine that the identified entry in the severity matrix data of the entity be modified. In the alternative, if the system receives, in step 526, a user input representative of a change to predicted modification to an identified entry in the severity matrix data, the system may determine that the predicted modification is to be modified prior to modifying the identified entry in the severity matrix data of the entity per one or more modifications by the user. An individual may accept or reject any particular portion of the predicted modification before proceeding to step 528. In alternative embodiments, no user confirmation may be needed. This may be a situation in which the system operates autonomously and merely updates database entries automatically without user confirmation before proceeding to step 530. Steps 522-526 may be implemented by receiving such confirmation data at a confirmation and modification system 361 as described in FIG. 3.

In step 528, the identified database entry in the severity matrix data and/or the machine learning model data store may be updated. The database entry may include the predicted modification automatically or the user confirmed modification, whether changed by a user or not. Accordingly, the severity matrix data and/or machine learning model data store now has been updated to account for the existing development operations data based upon changes over time to the overall system. Again, this process may occur separately or concurrently for many incidents and/or development operations data. Finally, in step 530, the machine learning model, such as prediction model 331 described in FIG. 3, may be modified to account for the confirmation by the user in step 524 or the change by the user in step 526.

One or more steps of the example may be rearranged, omitted, and/or otherwise modified, and/or other steps may be added.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
compiling, by a first computing device, ownership data, metric data, and severity matrix data as input data to a machine learning model data store, wherein the ownership data comprises data representative of assets of an entity and data representative of relationships between the assets, wherein the metric data comprises data representative of development operations tools metric data of the assets, and wherein the severity matrix data comprises a plurality of entries, wherein each entry comprises data representative of a severity of a consequence of a particular incident occurrence affecting the metric data;
receiving, from a second computing device, refinement data to a first machine learning model trained to recognize one or more relationships between the input data in the machine learning model data store, wherein the refinement data updates the input data in the machine learning model data store;
predicting, via a second machine learning model trained to recognize one or more relationships between the input data in the machine learning model data store and new metric data representative of a new development operations tools metric data of the assets, a new entry to add to the severity matrix data, the new entry comprising data representative of a severity of a consequence of a particular incident occurrence affecting the new metric data; and
based upon the predicted new entry, outputting a notification of the predicted new entry.

2. The method of claim 1, further comprising receiving a user input representative of a confirmation of adding the new entry to the severity matrix data.

3. The method of claim 2, further comprising adding the new entry to the severity matrix data.

4. The method of claim 1, wherein the predicting the new entry comprises identifying one or more specific characteristics of entries within the severity matrix data and the new metric data.

5. The method of claim 4, wherein the one or more characteristics include one or more of cloud infrastructure, physical infrastructure, a recovery time objective, or a customer base.

6. The method of claim 1, wherein the first and second computing devices are the same computing device.

7. The method of claim 1, further comprising receiving a user input representative of a modification to the new entry to the severity matrix data.

8. The method of claim 7, further comprising adding the modified new entry to the severity matrix data.

9. The method of claim 7, further comprising modifying the second machine learning model based on the received user input.

10. The method of claim 1, further comprising receiving, by the first computing device, the ownership data.

11. The method of claim 1, further comprising receiving, by the first computing device, the metric data.

12. The method of claim 1, further comprising receiving, by the first computing device, the severity matrix data.

13. The method of claim 1, further comprising receiving, by the second computing device, the new metric data.

14. A method comprising:
compiling, by a first computing device, ownership data, metric data, and severity matrix data as input data to a machine learning model data store, wherein the ownership data comprises data representative of assets of an entity and data representative of relationships between the assets, wherein the metric data comprises data representative of development operations tools metric data of the assets, and wherein the severity matrix data comprises a plurality of entries, wherein each entry comprises data representative of a severity of a consequence of a particular incident occurrence affecting the metric data;
identifying one entry of the development operations tools metric data for input to a second machine learning training model trained to recognize one or more relationships between the input data in the machine learning model data store and the identified entry;
predicting, via the second machine learning model, a modification to the identified entry, the modification comprising a change to the data representative of the severity of the consequence of the particular incident occurrence affecting the identified entry; and
based upon the predicted modification, outputting a notification of the predicted modification to the identified entry.

15. The method of claim 14, further comprising receiving a user input representative of a confirmation of modifying the identified entry.

16. The method of claim 15, further comprising modifying the identified entry to the severity matrix data.

17. The method of claim 14, wherein the predicting the modification comprises identifying one or more specific characteristics of the identified entry and other entries within the severity matrix data.

18. The method of claim 14, further comprising receiving a user input representative of a change to the predicted modification to the identified entry to the severity matrix data.

19. One or more non-transitory media storing instructions that, when executed by one or more processors, cause the one or more processors to perform steps comprising:
compile, ownership data, metric data, and severity matrix data as input data to a machine learning model data store, wherein the ownership data comprises data representative of assets of an entity and data representative of relationships between the assets, wherein the metric data comprises data representative of development operations tools metric data of the assets, and wherein the severity matrix data comprises a plurality of entries, wherein each entry comprises data representative of a severity of a consequence of a particular incident occurrence affecting the metric data;
receive refinement data to a first machine learning model trained to recognize one or more relationships between the input data in the machine learning model data store, wherein the refinement data updates the input data in the machine learning model data store based upon new metric data representative of a new development operations tools metric data of the assets;
predict, via a second machine learning model trained to recognize one or more relationships between the input data in the machine learning model data store and the new metric data, a new entry to add to the severity matrix data, the new entry comprising data representative of a severity of a consequence of a particular incident occurrence affecting the new metric data; and
based upon the predicted new entry, output a notification of the predicted new entry.

20. The one or more non-transitory media storing instructions of claim 19 that, when executed by the one or more processors, cause the one or more processors to perform a further step comprising receive a user input representative of a confirmation of adding the new entry to the severity matrix data.
